(19) United States
(12) Patent Application Publication
(10) Pub. No.: US 2005/0105559 A1
(43) Pub. Date: May 19, 2005

(54) Methods and systems for providing transport of media gateway control commands using high-level datalink control (HDLC) protocol

(75) Inventors: Thomas Alan Cain, Plano, TX (US); Chang De Yan, Plano, TX (US); Simon Hsi-Min Shie, Plano, TX (US)

Correspondence Address: JENKINS, WILSON & TAYLOR, P. A., 3100 TOWER BLVD, SUITE 1400, DURHAM, NC, 27707, US

(73) Assignee: Santera Systems, Inc.

(21) Appl. No.: 10/714,106

(22) Filed: Nov. 14, 2003

(51) Int. Cl. H04J 3/00

(52) U.S. Cl. 370/498; 370/401

(57) ABSTRACT

A media gateway controller can manage a remote media gateway by sending standard media gateway control commands over an HDLC channel in a time division multiplexed link. The media gateway control commands are sent from the media gateway controller to a local media gateway, where the commands are encapsulated in a command packet and placed in the information field of an HDLC frame. The remote media gateway receives the HDLC frame, removes the media gateway control command, and takes the steps necessary to process the command. The command packet may include a packet header that identifies the type of command contained in the packet.

### TECHNICAL FIELD

The present invention relates to methods and systems for transporting media gateway control commands over high-level data link control (HDLC). More particularly, the present invention relates to methods and systems for remote management of a media gateway using media gateway control (MEGACO/H.248) commands embedded in HDLC frames transported over time-division multiplex (TDM) links.

### BACKGROUND ART

Telecommunication networks originated over a century ago and continue to evolve, driving the development of new standards, protocols, and topologies to provide new and optimize existing telephony services. The SS7 (Signaling System 7) protocol and other signaling protocols have been developed to provide digital out-of-band signaling for both the landline and wireless telephone networks. The modern public switched telephone network (PSTN) uses signaling messages to establish telephone call connections and provide advanced services. These signaling messages are transported over signaling links, which are typically TDM communications channels. The TDM communications channels used for PSTN call signaling are usually separate from other networks, such as data networks, for enhanced reliability and security.

Data networks, such as the Internet and private data networks, have been developed in parallel with the evolving PSTN. While the function of the PSTN is primarily to provide end-to-end voice connections between telephone service subscribers, data networks were developed to communicate data between the interconnected computers. Because data communications over the Internet are less delay sensitive and less critical to national security, the protocols developed for the Internet do not have the inherent reliability as those developed for PSTN.

Over time, the functions provided by the PSTN have become increasingly more sophisticated and the line between data networks and PSTN has blurred. For example, data protocols are being used with increasing frequency to transport signaling and network management information between elements of the PSTN and enable PSTN users to receive advanced services.

FIG. 1 is a block diagram of a portion of the PSTN network 100. In the PSTN network, a host 102 provides basic control functions, such as call processing and maintenance, for downstream equipment. For example, downstream from the host 102 is a remote switching unit (RSU) 104 and a remote line unit (RLU) 106. The RSU 104 may provide switching for downstream RLUs 106 or may provide local loop service to individual subscribers (not shown). Likewise, RLUs 106 may provide local loop service to subscribers (not shown) and local switching between the RLUs subscribers to complete local calls. Calls made to locations not served by the RLU 106 are forwarded upstream to the RSU 104.

In some instances, it may be desirable to replace legacy PSTN network elements, such as remote switching systems with new network elements, such as IP-capable media gateways to provide enhanced services to subscribers located in remote areas. However, in areas where separate data and PSTN communications facilities have not evolved, the management of sophisticated network elements, such as media gateways, cannot easily be accomplished using signaling protocols standardized for media gateways. For example, media gateway control protocols, such as MCGP and MEGACO are typically transmitted to media gateways over data networks using UDP/IP. Conventional telecommunications signaling links interconnecting central offices with remote switching equipment used proprietary transport protocols unsuitable for carrying media gateway control commands.

One possible solution for a telecommunications service provider who desires to replace existing legacy equipment with IP-based media gateways is to construct an IP network separate from the existing telecommunications signaling network and connect the media gateway controllers to the remote media gateways via the IP network. However, constructing a separate IP network requires the deployment of multiple Ethernet switches and IP routers, which increases the cost of providing supplementary services to subscribers located in remote areas.

Accordingly, there is a need to provide a mechanism to permit management and control of remote network equipment using available TDM links and standard protocols.

### SUMMARY OF THE INVENTION

According to one aspect, the present invention includes a method for transmitting a media gateway control command from a media gateway controller to a remote media gateway. As used herein, the term “media gateway control command” refers to any command that may be originated or forwarded by a media gateway controller to a remote media gateway. Examples of media gateway control commands include call control commands, network management messages, and media gateway maintenance commands.

In one exemplary implementation, the media gateway controller is in communication with a local media gateway, and the local media gateway has an interface to a TDM link to the remote media gateway. The media gateway control command is sent from the media gateway controller to the local media gateway. The local media gateway inserts the media gateway control command into a command packet, inserts the command packet into an HDLC frame and transmits the frame to the remote media gateway over the TDM link. The remote media gateway receives the HDLC frame, removes the command packet and removes the media gateway control command from the command packet.

In accordance with another aspect, the invention includes a media gateway having a plurality of network interfaces for sending and receiving media streams to and from external networks and a plurality of voice processing resources operatively associated with the network interfaces for processing the media streams received from the external networks. The media gateway also includes a command interface for receiving commands from a media gateway controller and a controller operatively associated with the network interfaces and the voice processing resources for controlling the network interfaces and the voice processing resources. The controller is operatively associated with the command interface and is capable of differentiating between commands intended for the media gateway and commands intended for a remote media gateway. An HDLC interface is operatively associated with the controller and is capable of sending and receiving HDLC frames. The HDLC frames may contain a media gateway control command or a response to a media gateway control command. The commands and responses are encapsulated in a command packet and transported in the information portion of the HDLC frame. The media gateway includes a TDM interface for sending the HDLC frames to a remote media gateway via a TDM link.

Another aspect of the invention includes a system for managing a remote media gateway. The system includes a media gateway controller and a local media gateway. The media gateway controller generates media gateway control commands. The local media gateway is operatively associated with the media gateway controller and is capable of differentiating between media gateway control commands received from the media gateway controller that are intended for the local media gateway and those not intended for the media gateway. The local media gateway has an HDLC interface and means for encapsulating media gateway control commands not intended for the local media gateway into HDLC frames for transmission by the HDLC interface. The local media gateway also has a TDM interface for communicating the HDLC frames to the remote media gateway.

Accordingly, it is an object of the present invention to provide methods and systems for sending media gateway control commands to a remote media gateway.

It is another object of the invention to provide methods and systems for controlling a media gateway using the existing telecommunications network infrastructure.

Some of the objects of the invention having been stated hereinabove, other objects will become evident as the description proceeds when taken in connection with the accompanying drawings as best described hereinbelow.

### BRIEF DESCRIPTION OF THE DRAWINGS

Preferred embodiments of the invention will now be explained with reference to the accompanying drawings of which:

FIG. 1 is a block diagram of a traditional PSTN network;

FIG. 2 is a block diagram of a communications network in which the present invention may be implemented;

FIG. 3 is a block diagram of a conventional HDLC frame;

FIG. 4 is a block diagram of a management command packet in accordance with the invention;

FIG. 5 is a block diagram of a media gateway and a media gateway controller that may be used to implement an embodiment of the invention;

FIG. 6 is a block diagram of a portion of an exemplary control module of a media gateway that may be used to implement an embodiment of the invention;

FIG. 7 is a flow diagram of an exemplary method for forwarding commands from a local media gateway to a remote media gateway in accordance with the invention; and

FIG. 8 is a flow diagram of an exemplary method for receiving, in a remote media gateway, media gateway control command encapsulated in an HDLC frame transmitted from commands from a local media gateway in accordance with the invention.

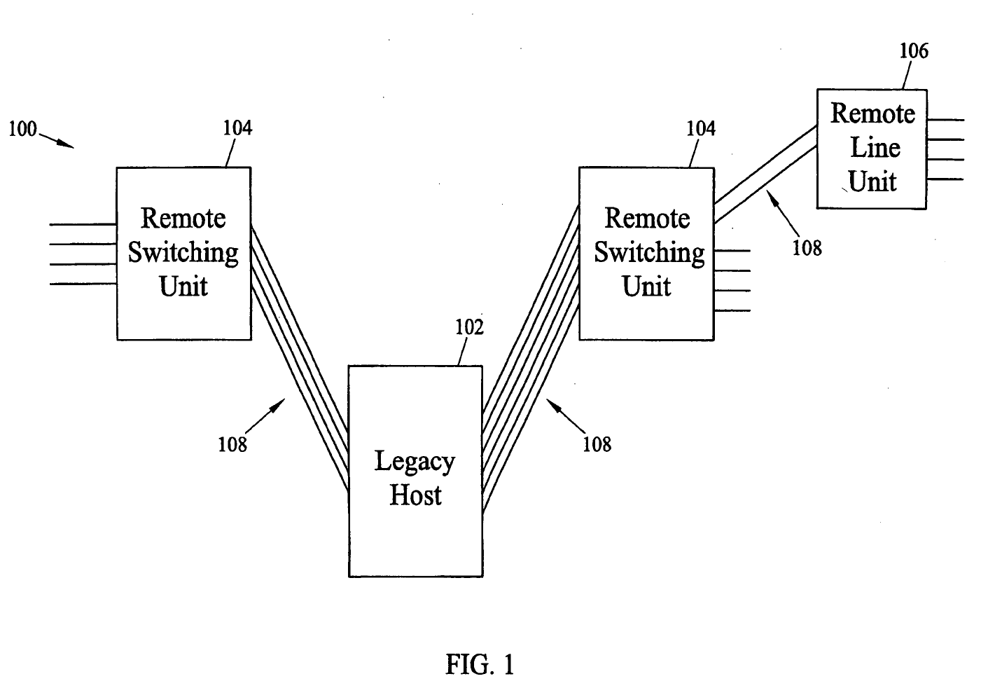

### DETAILED DESCRIPTION OF THE INVENTION

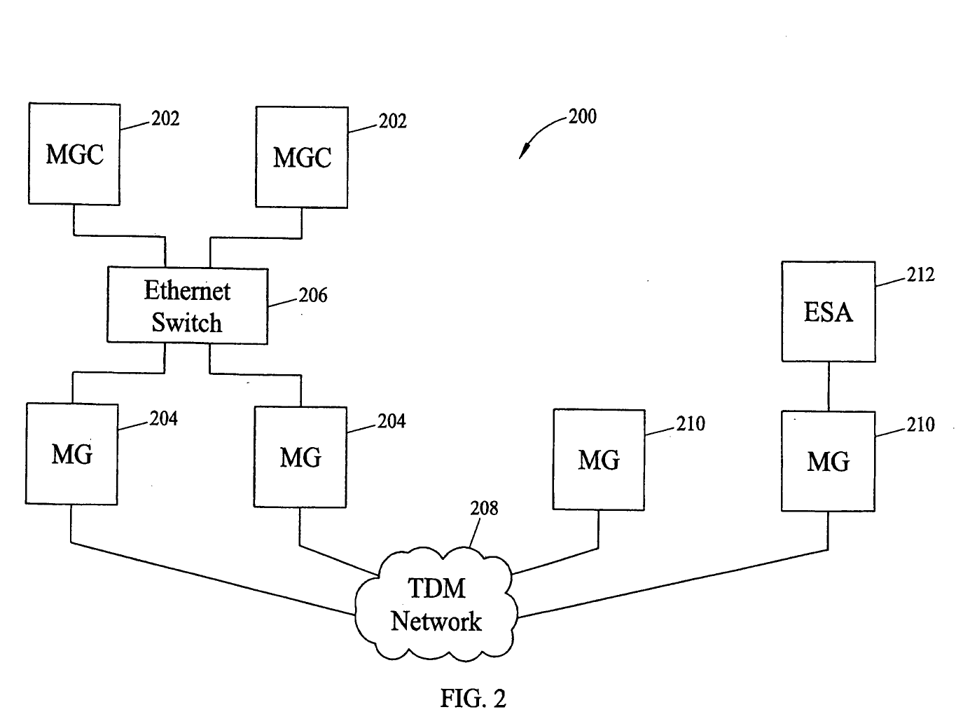

FIG. 2 is a block diagram of a communications network 200 in which the present invention may be implemented. A media gateway controller 202 communicates with a local media gateway 204 through an Ethernet port (not shown). The media controller 202 may be connected directly to the local media gateway 204 or the media gateway controller 202 may be connected to the local media gateway 204 through an Ethernet switch 206. Using the Ethernet switch 206 allows the media gateway controller 202 to manage more than one local media gateway 204 or permits more than one media gateway controller 202 to manage the local media gateways 204. If more than one media gateway controller 202 is present, one media gateway controller 202 may be designated as an active media gateway controller 202 and the other as a backup controller in the event that the active controller fails.

Each media gateway 204 includes a time division multiplex (TDM) interface for connection to a TDM network 208. TDM network 208 may be the same TDM network that was previously used to carry voice and data between a central office and a remote end office. The TDM network uses time slots to provide digitized voice and data connectivity. Other media gateways 210, remote to the local media gateways 204, are similarly connected to the TDM network 208. Thus, the TDM network 208 provides connectivity between local media gateways 204 and remote media gateways 210. By designating certain time slots as management channels, the TDM network 208 can be used to provide a pathway through which commands from the media gateway controller 202 can be sent to the remote media gateways 210 and any other network supported equipment, such as emergency standalone (ESA) processor 212,thus eliminating the need to provide a media gateway controller local to the remote media gateways 210. In addition, because existing TDM links may be used to carry the media gateway control signaling, the need for constructing a new data network between MGCs 202 and remote MGs 210 is reduced. Nevertheless, it may be desirable to use both a data network and a TDM network to carry media gateway control signaling between MGCs 202 and remote MGs 210 to provide, for example, a primary and a secondary signaling pathway.

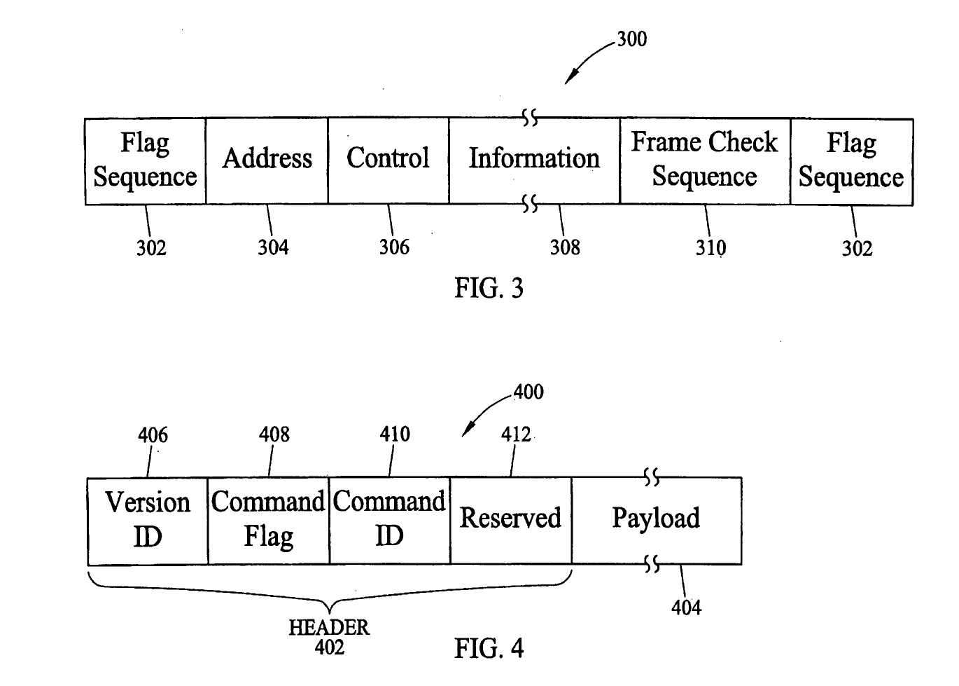

In accordance with one aspect of the invention, a media gateway control command is embedded within an HDLC frame and transmitted to a remote media gateway using one or more time slots in a TDM link. FIG. 3 is a block diagram of a conventional HDLC frame 300. The HDLC protocol is synchronous and relies on the physical layer for clocking and synchronization of the transmitter/receiver. An HDLC frame starts and ends with a flag sequence field 302 that contains the delimiter flag 0x7E. All data stations that are attached to the data link continuously hunt for this sequence to distinguish the beginning and ending of frames. The HDLC protocol uses a zero insertion/deletion process (bit-stuffing) to ensure that a data bit pattern matching the delimiter flag does not occur in another field.

Following the flag sequence field 302 is an address field 304. The contents of the address field depend on whether the HDLC frame contains a command or response. In command frames, the address field 304 identifies the data station for which the command is intended. In response frames, the address field 304 identifies the data station from which the response originated. The address field 304 is typically either 8 or 16 bits wide. When carrying media gateway control commands to a remote media gateway, the address field 304 may be set to the MAC address of the remote media gateway.

Following the address field 304 is an 8-bit control field 306. The control field 306 indicates the class of commands or responses to be carried out by the frame and contains sequence numbers that specify any sequence that the command must follow. The control field 306 indicates the type of command that is contained in an information field 308 that follows the control field 306. When the information field 308 carries a media gateway control command, the control field 306 may be set to a predetermined value that the media gateway uses to identify that a media gateway control command is present.

The data or information field 308 may include any user-specified bits, other than the delimiter flag. In most cases, the information field 308 is formatted in an N-by-8-bit structure (e.g., ASCII text). However, each element in the information field 308 may be an unspecified number of bits. If the number of bits in the information field 308 is not a multiple of eight, padding bits may be added to the data in the information field 308 to achieve an octet alignment. As will be described in detail below, in accordance with the present invention, the information field 308 may carry media gateway control commands.

Following the information field 308 is the frame check sequence field 310. Any cyclic redundancy check (CRC) type frame checking sequence may be used, although 16-bit and 32-bit sequences are the most common. The CRC in the frame check sequence field 310 is used to determine whether the HDLC packet was received without errors. A second flag sequence field 302 follows the frame check sequence field 310 and terminates the HDLC packet 300.

In accordance with the invention, media gateway management or control commands may be embedded in the information field 308 of the HDLC frame 300. FIG. 4 is a block diagram of a management command packet 400 in accordance with the invention. The management command packet 400 includes a packet header 402 and a packet payload 404. In one embodiment, the packet header 402 contains four 8-bit fields. The first field is a version identification field 406 that indicates the version of the command packet 400. Changes to the content or placement of the fields in the packet may be desirable to accommodate different applications or different versions of the same application. These changes may be indicated to the receiving application by a change in the version identification field 406.

The second field in the packet header 402 is a command flag 408 that indicates the type of payload contained in the command packet 400. For example, in one embodiment, 0x00 indicates the payload is an IP packet and a 0x05 indicates that the payload is a media gateway management command. Other data values may be defined to identify other types of payloads.

The third field in the packet header 402 is a command identification field 410. The command identification field 410 identifies the destination interface for IP packets to be sent to a remote media gateway and indicates the command ID for media gateway management commands sent to the remote media gateway. For example, if the payload of the command packet includes an IP packet, such as a network management packet or a call control packet, the command identification field 410 may be set to 0x01. If the payload contains a media gateway maintenance packet, the command identification field 410 may be set to 0x00. These values in the command identification field 410 indicate to the receiving media gateway as to whether the command packet should be sent to the management interface or the call control interface. If the payload stores a media gateway management command, command identification field 410 stores a value indicating the command ID.

It should be noted that the composition and arrangement of the packet header is intended to be exemplary and is not intended to limit the invention. The placement of the fields in the packet header 402 can be changed, or fields can be eliminated without altering the function of the packet header. For example, the version ID field 406 and the reserved field 412 can be eliminated from the packet to produce a more compact packet header. These and other modifications to the packet header are intended to fall within the scope of the invention.

As noted above, the content of the packet payload 404 is identified by the command flag 408. For example, the command flag 408 may be set to a predetermined value to indicate that the packet payload 404 is a command packet when the packet payload 404 contains maintenance and control commands to test or configure the destination media gateway. Examples of functions initiated by the command packet may include performing a test of the HDLC interface, setting up HDLC channels, or performing an upgrade of the media gateway software. The command flag 408 may be set to a different value when the packet payload 404 contains a media gateway call control or network management message.

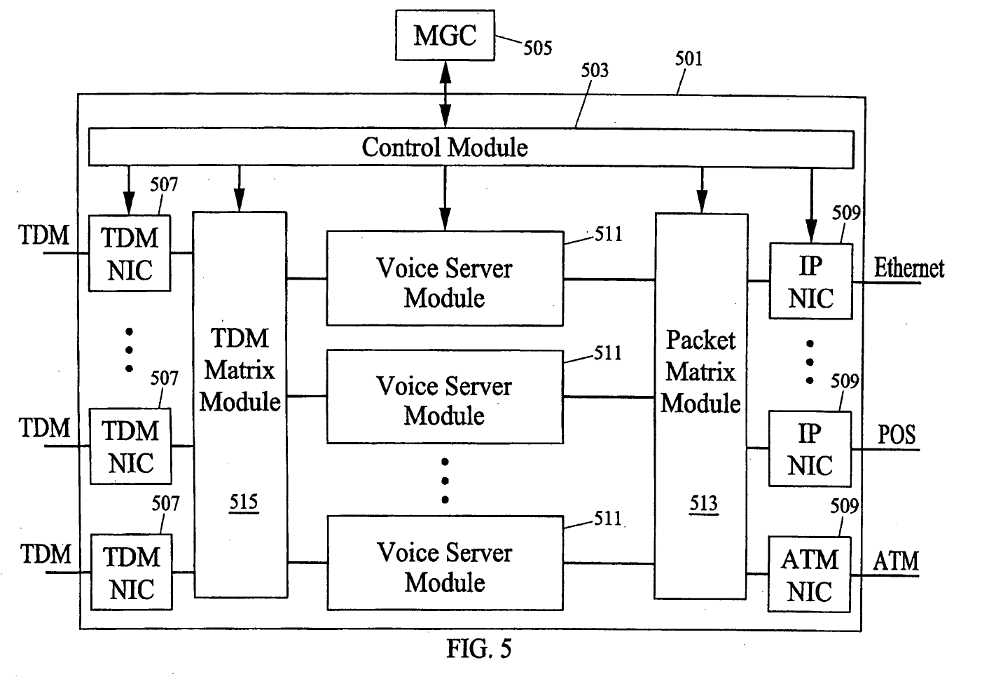

The processing of command packets may be better understood through a brief description of an exemplary implementation in a media gateway. FIG. 5 is a block diagram of a media gateway 501 that may be used to implement an embodiment of the invention. The media gateway 501 includes a control module 503 that functions as the command interface for a media gateway controller 505. Commands from the media gateway controller 505 are received and processed by the control module 503. The control module 503 may, in turn, provide instructions to or acquire information from other modules within the media gateway 501 in order to comply with the commands from the media gateway controller 505.

The media gateway 501 may also include interfaces for sending and receiving media streams to and from a plurality of different types of networks. For example, the media gateway 501 may also include time division multiplexed (TDM) network interface cards 507. TDM network interface cards 507 send and receive media streams from external TDM networks. TDM network interface cards 507 may implement any suitable physical layer protocol for sending and receiving media streams over TDM links. For example, each TDM NIC 507 may terminate one or more TDM voice trunks.

In addition to TDM network interface cards, the media gateway 501 may include packet network interface cards 509. Each packet network interface card 509 may implement network layer functions, such as packet forwarding functions, including Internet protocol (IP) forwarding functions. In the illustrated example, different packet network interface cards are provided to connect to external Ethernet, Packet Over SONET (POS), and asynchronous transfer mode (ATM) networks.

In FIG. 5, the media gateway 501 includes voice server modules 511, which may include circuitry for implementing one or more voice over packet protocols, such as Real-time Transmission Protocol (RTP). In order to switch packets from network interface cards 509 to the appropriate voice server module 511, the media gateway 501 includes a packet matrix module 513. The packet matrix module 513 switches packets under the control of the control module 503. In addition to packet matrix module 513, media gateway 501 includes a TDM matrix module 515 for switching data in TDM time slots between TDM NICs 507 and voice server modules 511. TDM matrix modules 515 are also controlled by control module 503.

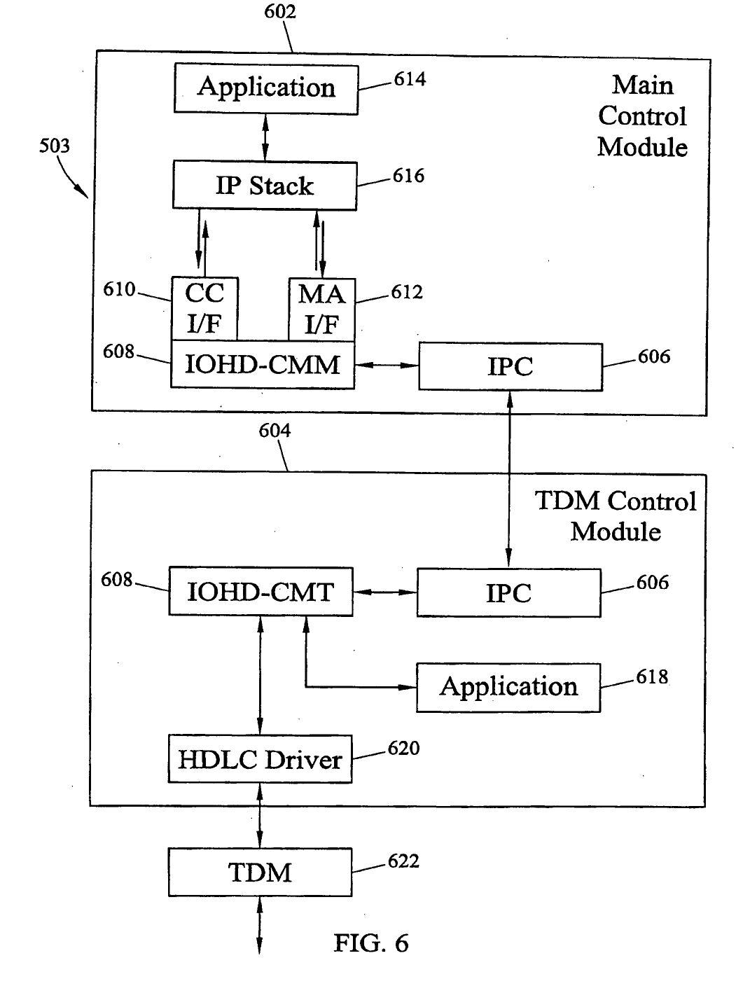

As noted above, the control module 503 functions as the command interface for the media gateway 501. The functions performed by the control module 503 may be divided between one or more processing units. FIG. 6 is a block diagram of a portion of the control module 503. In FIG. 6, the control module 503 includes a main control module 602 and a TDM control module 604. Control module 503 may include other modules to perform other functions of the media gateway without departing from the scope of the invention.

In a multiprocessor system, it is desirable to have some mechanism available to permit the various processors to communicate with each other. Accordingly, main control module 602 and TDM control module 604 each include interprocessor communications (IPC) circuitry 606. In the exemplary embodiment, the IPC 606 includes circuitry for sending and receiving Ethernet frames. Frames received by the IPC 606 are checked for errors and then forwarded to an I/O handling device (IOHD) 608. In the main control module 602, the IOHD 608 includes two interfaces. One interface is a call control interface 610. The other interface is a management interface 612. Each interface may be assigned a different IP address. Both the call control interface 610 and the management interface 612 communicate with a main control module application 614 by forwarding packets through an IP stack 616. After receiving the packets, the main control module application 614 may perform a function requested by control commands in the packets or may initiate commands to another control module. Information and commands from the main control module application 614 are forwarded through the IP stack 616 to the appropriate interface, that is, either the call control interface 610 or the management interface 612. The IOHD 608 forwards these packets through the IPC 606 to the appropriate processor module.

As shown in FIG. 6, the main control module 602 may communicate with the TDM control module 604. The TDM control module 604 includes an IPC 606 and IOHD 608. The TDM control module 604 also includes an associated TDM control module application 618 for executing various maintenance and configuration functions. The main function of the TDM control module 604 is to provide an HDLC interface to the media gateway.

In accordance with the invention, media gateway control commands are transmitted from a media gateway controller to a remote media gateway using TDM channels. In FIG. 6, TDM NICs 507 provide interfaces to external TDM channels so that HDLC driver 620 on the TDM control module 604 can send call control and management commands to a remote media gateway. The external TDM links to the remote media gateway may be existing TDM links used to carry call signaling and bearer channel data between PSTN switching offices. Because existing TDM channels can be used to carry HDLC-encapsulated media gateway control commands according to the present invention, the need for constructing a stand-alone IP network for such communication is reduced.

Moreover, in FIG. 6, TDM NICs 507 may provide redundant access to the external TDM links. As a result, if an HDLC channel on one external TDM link fails, connectivity with the remote media gateway is not lost because traffic can be dynamically switched to a new HDLC channel on a TDM channel accessible via an alternate TDM NIC 507. For example, HDLC driver 620 may detect faulty HDLC links and dynamically switch traffic to an alternate link. Thus, by using redundant TDM links and redundant TDM network interfaces provided by a media gateway, the present invention provides reliable communications with a remote media gateway.

The present invention is not limited to using the TDM interfaces provided by a media gateway to send media gateway management, network management, and call control commands from a media gateway controller to a remote media gateway. In an alternate implementation, a media gateway controller may directly terminate one or more TDM links and contain the same functionality described with respect to FIG. 6 for sending and receiving HDLC frames to and from a remote media gateway controller via the TDM links. Using a media gateway or a media gateway controller to access TDM links and send call control commands, network management commands, and media gateway maintenance commands via TDM channels is intended to be within the scope of the invention.

When processing a received HDLC frame, the HDLC driver 620 verifies the integrity of the HDLC frame 300, described above with reference to FIG. 3, and removes the information field 308 from the HDLC frame 300. As described above with reference to FIG. 4 and in accordance with the invention, the information field 308 contains a management command packet 400. The HDLC driver 620 forwards the command packet 400 to the IOHD 608 for further processing. The IOHD 608 on the TDM control module 604 forwards the command packet 400 to the IOHD 608 on the main control module 602 using the IPC 606. The IOHD 608 on the main control module 602 examines the contents of the command packet 400.

As described above with respect to FIG. 4, the management command packet 400 includes a packet header 402 and a packet payload 404. The IOHD 608 examines the packet header 402 to determine the destination of and type of packet in the packet payload 404. This may be accomplished by examining the command flag 408 of the command packet 400. If the packet payload contains an IP packet, the IOHD 608 examines the command identification field 410 to determine the destination interface ID. Based on the destination interface ID, the packet payload is forwarded to the main control module application 614 using either the management interface 612 or the call control interface 610.

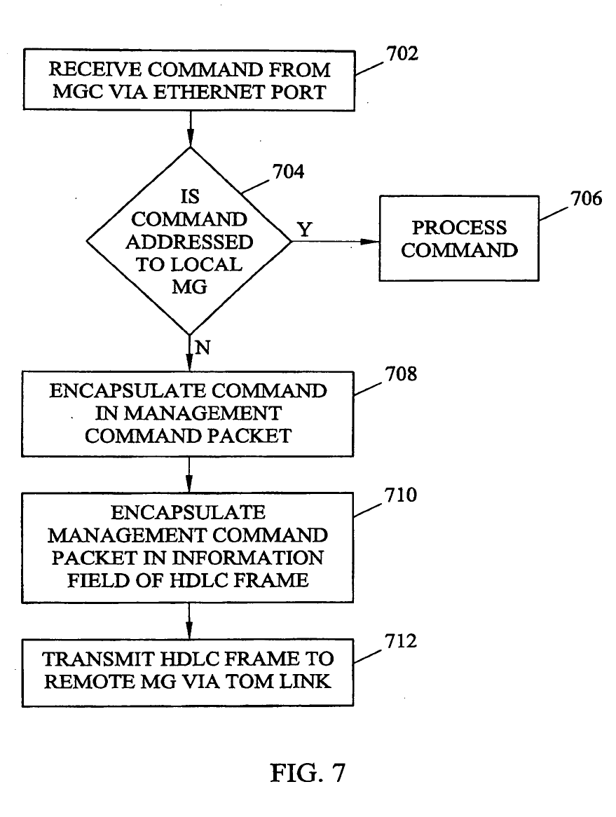

Accordingly, a media gateway controller can manage a remote media gateway by sending media gateway control commands through a local media gateway, over existing TDM links, to the remote media gateway. FIG. 7 is a flow diagram of an exemplary method for forwarding commands from a local media gateway to a remote media gateway through existing TDM links in accordance with the invention. In step 702, the local media gateway 204 receives a command from the media gateway controller through, for example, the Ethernet port of the local media gateway 204. In step 704, the local media gateway 204 determines whether the command is addressed to the local media gateway 204 or the remote media gateway 210. If the command is addressed to the local media gateway 204, then the local media gateway 204 processes the command in the normal manner (step 706). This may include, for example, executing steps in the control module of the local media gateway 204.

If the local media gateway 204 determines that the command is addressed to the remote media gateway 210, then the local media gateway 204 encapsulates the command in a management command packet, as shown in step 708. In step 710, the local media gateway 204 encapsulates the management command packet in the information field of an HDLC frame. The HDLC frame is then transmitted to the remote media gateway 210 via the TDM network 208 (step 712).

It should be appreciated that the local media gateway 204 may support more than one remote media gateway 210. In this case, the local media gateway 204 may determine, in step 704, which of several remote media gateways 210 the command is intended based, for example, on the destination address of the command received from the media gateway controller. Since different TDM links may be used to support each of the remote media gateways, the local media gateway 204 may select the appropriate TDM link to use to transmit the encapsulated command in step 712.

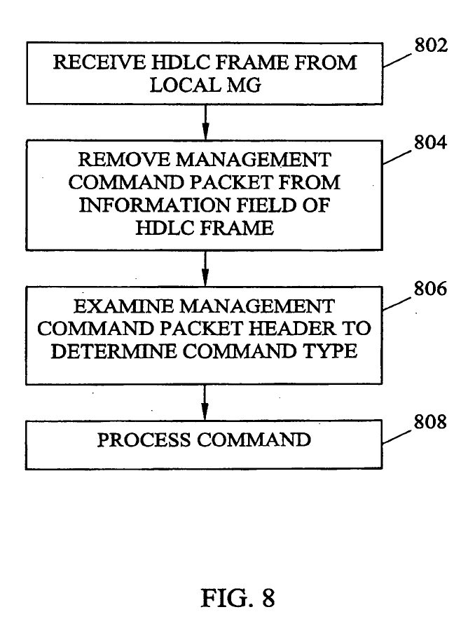

The remote media gateway 210 performs complementary steps to remove the command from the HDLC frame. FIG. 8 is a flow diagram of exemplary steps performed by the remote media gateway 210 to recover the media gateway control command in accordance with the invention. In step 802, the remote media gateway 210 receives the HDLC frame. The remote media gateway 210 removes the management command packet from the information field of the HDLC frame (step 804). In step 806, the remote media gateway 210 examines the management command packet header to determine the command type. The remote media gateway 210 performs the steps necessary to process the command based on the command type (step 808). Examples of these steps are noted above with reference to FIG. 6.

It should be appreciated that the remote media gateway 210 may support other network elements. For example, an emergency standalone (ESA) processor may be connected to the remote media gateway 210 through, for example, the remote media gateway's Ethernet port. As is known in the art, the ESA provides local call processing and 911 access in the event of a loss of connectivity between the remote media gateway 210 and the media gateway controller. Under normal operations, the ESA processor operates in a dormant mode. In the dormant mode, the ESA sends and receives keep-alive messages to the media gateway controller and receives periodic database synchronization updates from the media gateway controller. If the ESA processor determines that both the ESA processor and the media gateway 210 can no longer communicate with the media gateway controller, then the ESA processor becomes active to provide basic line-to-line and line-to-trunk call processing over in-band trunks. Thus, the remote media gateway controller 210 may be used to encapsulate and transport messages between the media gateway controller and the ESA.

The remote media gateway 210 may undertake similar steps to those shown in FIG. 7 in order to send a response back to the media gateway controller 202 through the local media gateway 204. Accordingly, the remote media gateway 210 may execute steps similar to steps 708 through 712. For example, the remote media gateway 210 may encapsulate a response in a management command packet. The management command packet may then be encapsulated in the information field of an HDLC frame. The HDLC frame may be transmitted from the remote media gateway 210 to the local media gateway 204. Similarly, the local media gateway 204 may execute steps similar to those shown in FIG. 8 to recover the response sent by the remote media gateway 210 and forward the response to the media gateway controller 202. For example, the local media gateway 204 may receive an HDLC frame from the remote media gateway 210. The local media gateway 204 may then remove a management command packet from the information field of the HDLC frame. The local media gateway 204 may then examine the management command packet header to determine that the command packet includes a response. The response would then be forwarded to the media gateway controller 202.

It should be appreciated that term “TDM link” or “TDM links” is used to describe one or more time slots on one or more TDM trunks in a TDM network. Time slots may be dynamically assigned to provide sufficient bandwidth to perform management and control functions. For example, additional time slots may be assigned during bandwidth intensive operations, such as a database download or control software upgrade, and then made available for call processing once the operation is complete. Moreover, separate TDM links may be provisioned such that control commands are sent over one TDM link and management commands are sent over another TDM link. One advantage to the separate provisioning of the management link and control link is that bandwidth could be independently allocated to each message type. Thus, the bandwidth allocated to the control link could be set based on the call capacity of the remote media gateway, while the bandwidth for the management link could be dynamically allocated. During peak call times, the bandwidth for the management link could be reduced independently of the control link bandwidth to permit greater call capacity while not decreasing call control throughput. Another advantage of separate provisioning is that the management link and the control link may be initially assigned to predetermined time slots, which may be desirable during the initial configuration of a media gateway, especially one at a remote location.

Accordingly, a system and method for providing remote management of a media gateway using a standard media gateway control protocol transmitted across a TDM link has been described. The system and method includes placing media gateway control commands within the information field of an HDLC frame and transmitting the HDLC frame across a TDM network from a local media gateway to a remote media gateway. The remote media gateway removes the media gateway control command from the HDLC frame and processes the command. Likewise, a response generated by a remote media gateway may be forwarded through the TDM network through a local media gateway and received by the media gateway controller. Thus, by encapsulating media gateway control commands in HDLC frames, media gateways can be remotely controlled over existing TDM links and without constructing a new data network.

It will be understood that various details of the invention may be changed without departing from the scope of the invention. Furthermore, the foregoing description is for the purpose of illustration only, and not for the purpose of limitation, as the invention is defined by the claims as set forth hereinafter.

1. A method for transmitting a media gateway control command from a media gateway controller to a remote media gateway using a high-level datalink control (HDLC) protocol, the method comprising:
(a) generating a media gateway control command;
(b) inserting the media gateway control command into a command packet;
(c) inserting the command packet into an HDLC frame; and
(d) transmitting the HDLC frame to a media gateway using a time division multiplexed (TDM) channel.

2. The method of claim 1 wherein generating a media gateway control command includes generating a MEGAGO command.

3. The method of claim 1 wherein generating a media gateway control command includes generating a media gateway control protocol (MGCP) command.

4. The method of claim 1 wherein inserting the media gateway control command into a command packet includes forming the command packet having a packet header portion and a packet payload portion.

5. The method of claim 4 wherein forming the command packet includes inserting a command flag in the packet header portion that indicates a type of payload contained in the packet payload portion.

6. The method of claim 5 comprising inserting the media gateway control command into an IP packet and wherein inserting the media gateway control command into a command packet includes inserting the IP packet in the packet payload portion and inserting a destination interface identifier for the IP packet in the packet header portion.

7. The method of claim 5 wherein inserting the media gateway control command into the command packet includes inserting the media gateway control command in the packet payload portion and inserting a command identifier in the packet header portion for identifying the media gateway control command.

8. The method of claim 1 wherein transmitting the HDLC frame to a media gateway using a TDM channel includes transmitting the HDLC frame from a media gateway controller to a media gateway located remotely from the media gateway controller using a TDM channel previously used to carry public switched telephone network (PSTN) data between PSTN switching offices.

9. The method of claim 8 wherein transmitting the HDLC frame to a media gateway includes transmitting the media gateway control command from a media gateway controller to a media gateway local to the media gateway controller and from the local media gateway to the media gateway located remotely from the media gateway controller.

10. A media gateway comprising:
(a) a plurality of network interfaces for sending and receiving media streams to and from external networks;
(b) a plurality of voice processing resources operatively associated with the network interfaces for processing the media streams received from the external networks;
(c) a command interface for receiving commands from a media gateway controller;
(d) a controller operatively associated with the network interfaces and the voice processing resources for controlling the network interfaces and the voice processing resources, the controller being operatively associated with the command interface and being capable of differentiating between commands intended for the media gateway and commands intended for a remote media gateway; and
(e) a high-level data link control (HDLC) interface operatively associated with the controller for encapsulating media gateway control commands intended for the remote media gateway in command packets, encapsulating the command packets in HDLC frames, and for forwarding the HDLC frames to the remote media gateway via a time division multiplexed (TDM) channel.

11. The media gateway of claim 10 wherein the plurality of network interfaces include a plurality of TDM network interfaces for sending and receiving data over TDM channels and wherein the HDLC interface is adapted to send the HDLC frames to the TDM network interfaces and the TDM network interfaces are adapted to send the HDLC frames to the remote media gateway via the TDM channels.

12. The media gateway of claim 11 wherein the TDM network interfaces provide redundant access to the TDM channels and wherein the controller is adapted to dynamically switch between TDM channels for sending the HDLC frames to the remote media gateway in response to failure of one of the TDM channels.

13. The media gateway of claim 10 wherein the plurality of network interfaces include a plurality of packet network interfaces for sending and receiving packetized media streams to and from external networks.

14. The media gateway of claim 10 wherein the HDLC interface is adapted to encapsulate call control commands intended for the remote media gateway in the command packets, to encapsulate the command packets in HDLC frames, and to forward the HDLC frames to the remote media gateway via a TDM channel.

15. The media gateway of claim 10 wherein the HDLC interface is adapted to encapsulate media gateway maintenance commands intended for the remote media gateway in the command packets, to encapsulate the command packets in HDLC frames, and to forward the HDLC frames to the remote media gateway via a TDM channel.

16. The media gateway of claim 10 wherein the HDLC interface is adapted to encapsulate network management messages intended for the remote media gateway in the command packets, to encapsulate the command packets in HDLC frames, and to forward the HDLC frames to the remote media gateway via a TDM channel.

17. The media gateway of claim 10 wherein the HDLC interface is adapted to insert a header in the command packet indicating whether a payload of the command packet carries a network management message, a call control message, or a media gateway maintenance message.

18. A system for managing a remote media gateway, the system comprising:
(a) a media gateway controller for generating media gateway control commands;
(b) a local media gateway operatively associated with the media gateway controller for sending and receiving media streams to and from external networks;
(c) a high-level data link control (HDLC) interface operatively associated with at least one of the media gateway and the media gateway controller for encapsulating media gateway control commands intended for a remote media gateway controller in HDLC frames; and
(d) at least one time division multiplexed (TDM) interface operatively associated with the HDLC interface for sending the media gateway control commands to the remote media gateway via a TDM channel.

19. The system of claim 18 wherein the media gateway controller is adapted to generate call control commands intended for the remote media gateway and to forward the call control commands to the remote media gateway via the HDLC interface.

20. The system of claim 18 wherein the media gateway is adapted to generate network management messages intended for the remote media gateway and to forward the network management messages to the remote media gateway via the HDLC interface.

21. The system of claim 18 wherein the media gateway controller is adapted to generate media gateway maintenance commands intended for the remote media gateway and to forward the media gateway maintenance commands to the remote media gateway via the HDLC interface.

22. The system of claim 18 wherein the HDLC interface and the TDM interface are located on the media gateway controller.

23. The system of claim 18 wherein the HDLC interface and the TDM interface are located on the media gateway.

24. The system of claim 18 wherein the at least one TDM interface includes a plurality of redundant TDM interfaces for redundantly connecting the media gateway controller to the remote media gateway.

25. The system of claim 24 wherein the plurality of redundant TDM interfaces are connected to the local media gateway and wherein the local media gateway is adapted to detect failure of any one of the TDM interfaces and to switch HDLC frames from the failed interface to any of the other TDM interfaces.

26. The system of claim 24 wherein the plurality of redundant TDM interfaces are connected to the media gateway controller and wherein the media gateway controller is adapted to detect failure of any one of the TDM interfaces and to switch HDLC frames from the failed interface to any of the other TDM interfaces.

27. The system of claim 18 wherein the HDLC interface is adapted to encapsulate the media gateway control commands in command packets and to encapsulate the command packets in the HDLC frames.

28. The system of claim 27 wherein the HDLC interface is adapted to construct a header for each of the command packets, each header including at least one identifier for indicating a type of media gateway control command included in the command packets.

29. The system of claim 18 wherein the TDM interface is adapted to forward the media gateway control commands to the remote media gateway using a TDM link formerly used to carry data between PSTN switching offices.

30. The system of claim 18 wherein the media gateway controller is adapted to send the media gateway control commands to the local media gateway and wherein the local media gateway is adapted to determine whether the media gateway control commands are addressed to it or to the remote media gateway.

31. The system of claim 30 wherein the local media gateway is adapted to process media gateway control commands that it determines are being addressed to it and to forward the media gateway control commands that it determines are addressed to the remote media gateway.
